(19) United States
(12) Patent Application Publication
(10) Pub. No.: US 2005/0174784 A1
(43) Pub. Date: Aug. 11, 2005

(54) Pumpkin light

(76) Inventor: David E. Conrey, Phelps, NY (US)

Correspondence Address: Stephen B. Salai, Esq.;Harter, Secrest & Emery LLP, 1600 Bausch & Lomb Place, Rochester, NY, 14604-2711, US

(21) Appl. No.: 10/772,475

(22) Filed: Feb. 5, 2004

(51) Int. Cl. F21V 33/00

(52) U.S. Cl. 362/431; 362/806

(57) ABSTRACT

A light system for illuminating a jack-o-lantern from the inside includes the hollow tubular support extending through a side wall of the jack-o-lantern, a first pressure plate attached to the tubular support and engaging an inside wall of the jack-o-lantern, a second adjustable pressure plate attached to the tubular support and engaging an outside wall of the pumpkin, a light attached to an end of the tubular support within the pumpkin and at least one electrical wire extending from the light within the pumpkin through the hollow tubular support and outside the pumpkin and attached to a source of electrical energy compatible with the light.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “SEQUENCE LISTING”

Not applicable.

### BACKGROUND OF THE INVENTION

1. Field of the Invention

This invention relates generally to illumination systems for pumpkins or similar gourds and more particularly to a system that supports a light within a pumpkin and provides for the passage of electrical wiring to power the light through the wall of the pumpkin.

2. Description of Related Art

The carving of pumpkins to create faces and the like for display on Halloween has been popular for years. Jack-o-lanterns, as carved pumpkins are sometimes called, are even more attractive to some if they are illuminated. Applicant believes that early jack-o-lanterns were illuminated by candles but more recently, it has become popular to illuminate jack-o-lanterns with electrically powered lights. Internal illumination creates a spooky looking display consistent with the darker side of the observance of Halloween (as opposed to the excess consumption side).

While lights generally and electric lights in particular have been placed within pumpkins to form illuminated jack-o-lanterns in the past, none of the approaches has been optimum. One common arrangement uses an electrically powered bulb powered from a battery or the like disposed within the pumpkin. A number of different arrangements have been proposed including self-contained devices having a battery, a light and a stand that rest on the inside base of a pumpkin thereby simulating as closely as possible the positioning of a candle. Other arrangements have included integrating the light with a cutout portion of the top of the pumpkin including the stem and hanging a light from the cut rim of the pumpkin with a hook extending over the sidewall thereof.

The position of a light within a pumpkin affects the quality of the display and there is an advantage to positioning the light relatively centrally with respect to the interior volume of the pumpkin. One problem is that pumpkins become soft after sitting outside on the porch for a week or two and the bottom tends to become soft first. Thus, it is an advantage to suspend the light above the bottom of the pumpkin rather than resting it on the bottom of the pumpkin rather than resting it on the bottom.

One previously used approach attached a battery holder and light to the wall of an artificial pumpkin with rivets. This has the advantage of disposing the light relatively centrally and off the bottom but relied on the non-natural construction of the wall of the pumpkin to make it suitable for riveting.

While almost all previously known pumpkin lights have relied on batteries for power, batteries have significant disadvantages as relates to the amount of illumination that can be produced and the life of the battery. There is a need for a pumpkin light that is brighter and longer lasting than known battery powered lights.

### BRIEF SUMMARY OF THE INVENTION

It is an object of this invention to provide a light for a jack-o-lantern that provides certain advantages over those heretofore used.

It is another object of this invention to provide a light for a jack-o-lantern that is positioned generally centrally within the interior volume of the pumpkin.

It is another object of the invention to provide a light for a jack-o-lantern that does not rest on the bottom of the pumpkin.

It is still another object of the invention to provide light for a jack-o-lantern that provides for the passage of an electrical wire from a power source outside the pumpkin to the light within the pumpkin.

Briefly stated and in accordance with a presently preferred embodiment of the invention, a light for illuminating the interior of a pumpkin or a like includes a hollow tubular support extending through a sidewall of the pumpkin, a first pressure plated hatched to the tubular support and engaging an inside wall of the pumpkin, a second adjustable pressure plate attached to the tubular support and engaging an outside wall of the pumpkin, a light attached to an end of the tubular support within the pumpkin, and at least one electrical wire extending from the light within the pumpkin through the hollow tubular support and outside of the pumpkin and attached to a source of electrical energy compatible with the light.

In accordance with the particular aspect of the invention, the tubular support comprises a threaded tube preferably a plastic or metal tube.

In accordance with still another aspect of the invention, the second adjustable pressure plate comprises a washer, preferably a flexible washer and a nut threaded on the tube.

In accordance with still a further aspect of the invention, the first pressure plate, within the pumpkin is interval with a socket for mounting the light.

While the novel aspects of the invention are set forth with particularity in the appended claims, the invention itself together with further objects and advantages thereof may be more readily understood by reference of the following detailed description of a presently preferred embodiment of the invention taken in conjunction with the accompanying drawing in which:

### BRIEF DESCRIPTION OF THE SEVERAL VIEWS OF THE DRAWING(S)

FIG. 1 is a side elevation of an illumination system for a pumpkin in accordance with this invention.

FIG. 2 is an elevation of a rubber gasket used in the preferred embodiment of the invention.

FIG. 3 is an elevation view of a light socket used within the pumpkin in accordance of the invention.

FIG. 4 is an elevation view of the electrical wires extending out from a threaded hollow tube in accordance with the invention; and

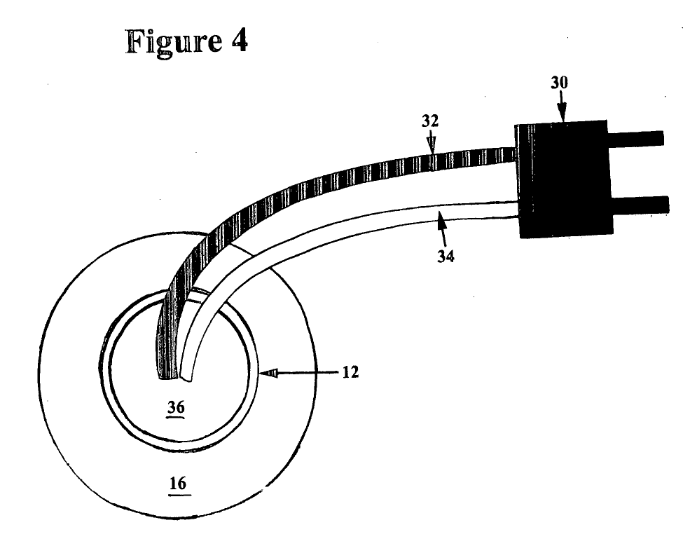

FIG. 5 shows an illumination system for a pumpkin mounted on the wall of a pumpkin.

### DETAILED DESCRIPTION OF THE INVENTION

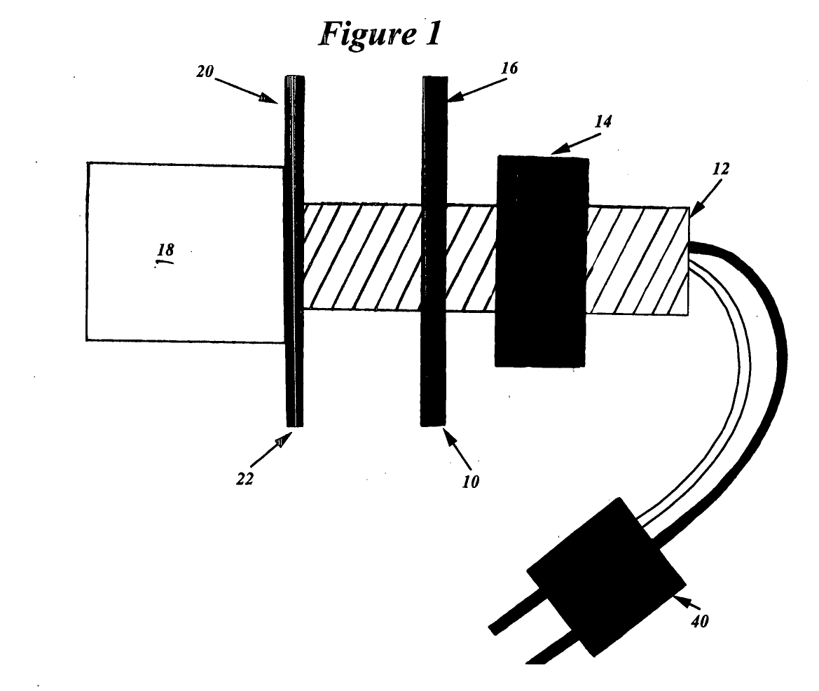

Referring now to FIG. 1, a light for illuminating a pumpkin or other gourd from within and apparatus for supporting the light generally centrally relative to the pumpkin as shown in a side elevational view. The pumpkin light indicated generally at 10 includes a threaded hollow rod 12 which is preferably made from metal or plastic. While the hollow rod is shown having threads formed along the entire length thereof, it will be appreciated that a rod selectively threaded where necessary to engage the interior threads of a plastic nut 14 may also be employed. Plastic nut 14 is threaded on the rod. While plastic is presently preferred, a metal nut or a nut made from another material could also be used. It is preferred that the threads of the rod and the nut be relatively course so that the nut can be quickly moved into position without requiring an excessive number of turns.

An external gasket, preferably an external rubber gasket is positioned on the threaded rod where it can be engaged by the nut.

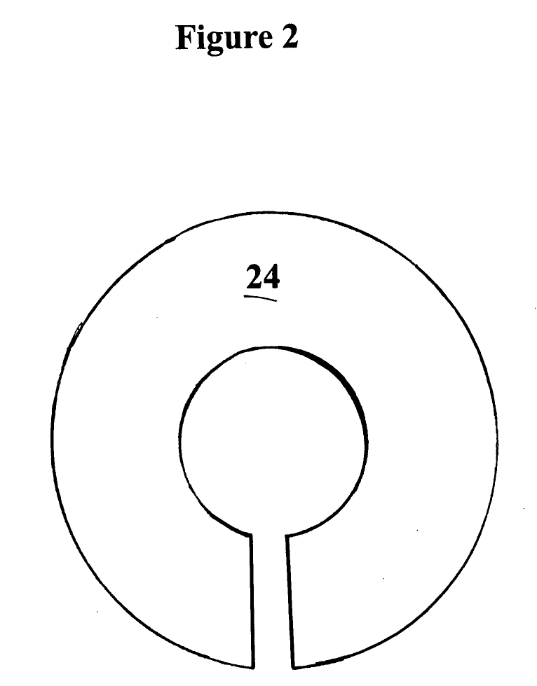

FIG. 2 is a side elevation of the gasket showing a split in the wall thereof that permits the gasket to be deformed and placed on the threaded hollow rod without passing the gasket over the entire length of the rod. This permits the gasket to be put into position quickly and easily and also permits the gasket to be placed on the rod even if the hole through the center of the gasket is smaller than the electrical connector described below.

A light socket 18 is attached to the rod 12 at one end thereof. The socket may have a fitting that threads on to the rod, or another fitting that extends into the inside of the threaded hollow rod or any other arrangement that relatively firmly attaches the light socket to the rod. Preferably, though not shown, the light socket is adjustable with respect to the rod. A conventional pivot or swivel or the like may be employed for this purpose.

An internal pressure plate preferably an internal rubber gasket is positioned on the rod adjacent to the light socket. While a separate gasket is shown in this embodiment of the invention, the internal gasket may be a metal plate integral with the light socket or a plate made from another material such as rubber, plastic or the like. As an alternative, the light socket itself may have a surface 22 that is large enough to satisfactorily engage the interior wall of the pumpkin and provide a surface against which plastic nut 14 may act to secure the light stably to the wall of the pumpkin.

Although not shown, in use, a bulb is engaged with light socket 18 to provide illumination.

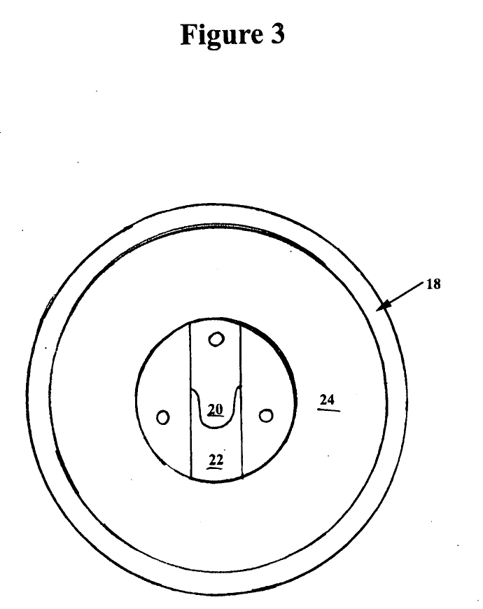

Light socket 18 may be any socket of the type generally known but a conventional socket of the type used with ordinary household light bulbs can be conveniently employed as shown in FIG. 3, preferably, the socket 18 includes an electrical connection 20 engaging one contact of a light bulb and a threaded electrical connection 23 engaging another contact of the light bulb. Preferably a water resistant gasket 24 is disposed in the socket to prevent rain, snow or moisture from the pumpkin from coming in contact with the electrical connections.

Power is lead from a power source external to the pumpkin by way of an electrical plug 30 which is preferably a fused electrical plug, a pair of electrical wires 32 and 34 that extent through the center of the threaded hollow rod to the light socket. Preferably, a water resistant sealant of calk 36 is placed in the end of the threaded hollow rod to prevent moisture from entering. The electrical plug may be a conventional fused electrical plug of the type that plugs into a common 115 volt electrical source. Suitable safety precautions such as ground fault interruption detection are preferably employed along with a fused electrical plug 30.

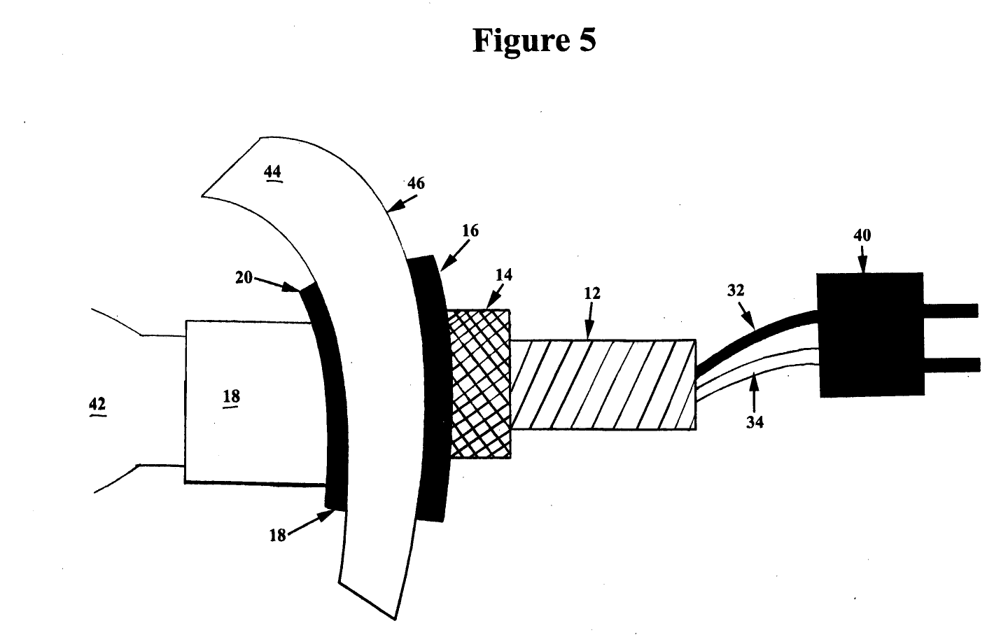

FIG. 5 shows the light of this invention installed through the wall of a pumpkin. A light bulb 42 is shown screwed into light socket 18 in a conventional manner. An internal rubber washer is disposed between surface 22 of light socket 18 and the inside wall of the pumpkin. Preferably, washer 20 is relatively thick and compliant so that it can form to the curved shape of the interior wall of the pumpkin 44.

An external rubber gasket 16, which is preferably of similar construction with interior gasket 20, bears against the exterior wall 46 of pumpkin 44. Preferably plastic nut 14 is threaded on hollow rod 12 and presses external gasket 16 against pumpkin wall 46 to form a mechanically solid attachment of the light to the pumpkin wall. Wires 32 and 34 are lead through the outside end of the threaded hollow rod 12 to fuse electrical plug 40 which can be connected to a source of electrical power.

While the invention has been described in connection with a presently preferred embodiment thereof, those skilled in the art will recognize that certain modifications and changes may be made therein without departing from the true spirit and scope of the invention which accordingly is intended to be defined solely by the appended claims.

1. A light for illuminating the interior of a pumpkin or the like comprising:
(a) a hollow tubular support extending through a side wall of the pumpkin;
(b) a first pressure plate attached to the support and engaging an inside wall of the pumpkin;
(c) a second adjustable pressure plate attached to the support and engaging an outside wall of the pumpkin;
(d) a light attached to an end of the hollow tubular support within the pumpkin; and
(e) at least one electrical wire extending from the light within the pumpkin, through the hollow tubular support and extending beyond the support and attached to a source of electrical energy compatible with the light.

2. The light of claim 1 in which the tubular support comprises a threaded tube.

3. The light of claim 2 in which the second adjustable pressure plate comprises a washer and a nut threaded on the tube.

4. The light of claim 1 in which the light comprises a light socket and a light source mounted in the socket.

5. The light of claim 4 in which the first pressure plate is integral with the light socket.

6. The light of claim 1 in which the second adjustable pressure plate comprises a flexible washer.

7. The light of claim 6 in which the hollow tubular support comprises a threaded tube and further comprising a nut threaded on the tube and engaging the flexible washer.

8. The light of claim 1 comprising an electrical connector connected to the wire.

9. The light of claim 1 in which the first pressure plate comprises a flexible washer.

10. The light of claim 9 in which the flexible washer comprises a split flexible washer.

11. The light of claim 1 comprising an adjustable coupling disposed between the light and the end of the hollow tubular support.

12. A light for illuminating a jack-o-lantern from within, and powered from a power source external to the jack o lantern comprising:
(a) a hollow light support substantially rigidly attached to a wall of the jack-o-lantern and extending there through;
(b) a light socket attached to the light support;
(c) a light bulb in the light socket; and
(d) an electrical wire connected to the light socket and lead through the support from inside the jack-o-lantern to a power source outside the jack o lantern.

13. The light of claim 12 comprising first and second pressure plates on the support engaging inside and outside surfaces of the jack o lantern respectively.

14. The light of claim 13 in which the pressure plates are flexible.

15. The light of claim 13 in which the light support comprises a threaded tube.

16. The light of claim 15 comprising at least one nut threaded on the tube for urging the pressure plates together to secure the light support to the jack o lantern.
